(19) United States
(12) Patent Application Publication
(10) Pub. No.: US 2021/0125182 A1
(43) Pub. Date: Apr. 29, 2021

(54) DETECTION OF A COMMON POINT OF COMPROMISE

(71) Applicant: Aetna Inc., Hartford, CT (US)

(72) Inventor: Salil Jain, Jackson Heights, NY (US)

(21) Appl. No.: 16/662,799

(22) Filed: Oct. 24, 2019

(51) Int. Cl. G06Q 20/40; G06Q 20/10; G06Q 20/20; G06Q 40/00; G06Q 30/06

(52) U.S. Cl. CPC G06Q 20/4016; G06Q 20/10; G06Q 30/0605; G06Q 40/12; G06Q 20/405; G06Q 20/20

(57) ABSTRACT

A common point of compromise (CPC) detection system obtains a data set of transaction data corresponding to a plurality of transactions performed by a plurality of users at a plurality of merchants; obtains an identification of one or more target merchants MB where fraudulent transactions have taken place; detects a potential CPC using the transaction information and the identification of the one or more target merchants MB; and outputs the detected potential CPC to facilitate responsive operations being performed in response to the detection of the potential CPC. Detecting the potential CPC includes: determining respective correlations between the one or more target merchants MB and each respective merchant MAi of a set of merchants MA, wherein the set of merchants MA includes merchants of the plurality of merchants at which a user's payment information was used in a transaction prior to being used in a transaction at the one or more target merchants MB; and detecting the potential CPC based on the determined correlations.

### BACKGROUND

Identify theft is a major problem affecting millions of people worldwide. There are many ways in which identity theft may occur, including, for example, skimming of credit/debit cards using malicious card readers and hacking of online data repositories to illicitly obtain users' payment information. Fraudsters who obtain stolen payment information (e.g., directly through identity theft, through purchasing the information via the dark web, or through other means) will then attempt to use the stolen payment information for fraudulent transactions.

A fraudster often starts with one or more test transactions to see if the stolen payment information works, and if it does, the fraudster may then try to cash out as much as possible through one or more transactions with a single merchant or a group of merchants (referred to herein as “target” merchant(s)). The target merchant or group of target merchants processing the fraudulent transaction(s) may or may not knowingly be in a criminal enterprise with the fraudster. Oftentimes, the target merchant or group of target merchants may simply have relatively weak security measures such that they are unable to detect the fraudulent nature of the transactions, and are thus chosen by the fraudster to process the fraudulent transaction(s).

### SUMMARY

In an exemplary embodiment, the present application provides a common point of compromise (CPC) detection system. The CPC detection system comprises one or more processors and one or more non-transitory computer-readable mediums having processor-executable instructions stored thereon, wherein the processor-executable instructions, when executed by the one or more processors, facilitate: obtaining a data set of transaction data corresponding to a plurality of transactions performed by a plurality of users at a plurality of merchants; obtaining an identification of one or more target merchants MB where fraudulent transactions have taken place; detecting a potential CPC using the transaction information and the identification of the one or more target merchants MB, wherein detecting the potential CPC includes: determining respective correlations between the one or more target merchants MB and each respective merchant MAi of a set of merchants MA, wherein the set of merchants MA includes merchants of the plurality of merchants at which a user's payment information was used in a transaction prior to being used in a transaction at the one or more target merchants MB; and detecting the potential CPC based on the determined correlations; and outputting the detected potential CPC to facilitate responsive operations being performed in response to the detection of the potential CPC.

In an exemplary embodiment, detecting the potential CPC further includes: identifying a set of users UB whose payment information was used in a transaction at the one or more target merchants MB; identifying the set of merchants MA, wherein the set of merchants MA includes merchants of the plurality of merchants where the payment information of users of the set of users UB was used prior to being used at the one or more target merchants MB; for each respective merchant MAi within the set of merchants MA, identifying a respective subset of users UAi from within the set of users UB whose payment information was used at the respective merchant MAi prior to being used at the one or more target merchants MB, and computing a respective probability value P(MAi∩MB) related to the subset of users UAi; for the one or more target merchants MB, computing an overall probability value PB; and for each respective merchant MAi within the set of merchants MA, computing a respective overall probability value PAi. And determining a respective correlation ρ_{MAi,MB} between the one or more target merchants MB and a respective merchant MAi is based on PAi, P(MAi∩MB), and PB.

In an exemplary embodiment, determining the respective correlation ρ_{MAi,MB} between the one or more target merchants MB and the respective merchant MAi based on PAi, P(MAi∩MB), and PB is according to: ρ_{MAi,MB}=(P(MAi∩MB)-PAi*PB)/sqrt(PAi*(1-PAi)* PB*(1-PB)).

In an exemplary embodiment, P(MAi∩MB) corresponds to the number of users in the subset of users UAi divided by the total number of users within the data set; the overall probability value PB corresponds to the number of users within the set of users UB divided by the total number of users within the data set; and the overall probability value PAi corresponds to the number of users which conducted a transaction at the respective merchant MAi within the data set divided by the total number of users within the data set.

In an exemplary embodiment, P(MAi∩MB) corresponds to the number of transactions at the respective merchant MAi by users in the subset of users UAi divided by the total number of transactions within the data set; the overall probability value PB corresponds to the number of transactions which occurred at the one or more target merchants MB within the data set divided by the total number of transactions within the data set; and the overall probability value PAi corresponds to the number of transactions which occurred at the respective merchant MAi within the data set divided by the total number of transactions within the data set.

In an exemplary embodiment, identifying the set of merchants MA further includes applying a filter criteria to exclude merchants with an insufficient number of relevant transactions associated therewith from the set of merchants MA.

In an exemplary embodiment, detecting the potential CPC based on the determined correlations includes comparing the determined correlations to a threshold.

In an exemplary embodiment, determining the respective correlations between the one or more target merchants MB and each respective merchant MAi of the set of merchants MA is based on using a Jaccard index.

In an exemplary embodiment, the responsive operations include: implementing monitoring in connection with payment information used at the detected potential CPC; sending a notification to users who have interacted with the detected potential CPC; deactivating forms of payment corresponding to the payment information used at the detected potential CPC; and/or restricting usage of forms of payment corresponding to the payment information used at the detected potential CPC.

In another exemplary embodiment, the present application provides a method for detecting a common point of compromise (CPC). The method comprises: obtaining, by a CPC detection system, a data set of transaction data corresponding to a plurality of transactions performed by a plurality of users at a plurality of merchants; obtaining, by the CPC detection system, an identification of one or more target merchants MB where fraudulent transactions have taken place; detecting, by the CPC detection system, a potential CPC using the transaction information and the identification of the one or more target merchants MB, wherein detecting the potential CPC includes: determining respective correlations between the one or more target merchants MB and each respective merchant MAi of a set of merchants MA, wherein the set of merchants MA includes merchants of the plurality of merchants at which a user's payment information was used in a transaction prior to being used in a transaction at the one or more target merchants MB; and detecting the potential CPC based on the determined correlations; and outputting, by the CPC detection system, the detected potential CPC to facilitate responsive operations being performed in response to the detection of the potential CPC.

In an exemplary embodiment, detecting the potential CPC further includes: identifying a set of users UB whose payment information was used in a transaction at the one or more target merchants MB; identifying the set of merchants MA, wherein the set of merchants MA includes merchants of the plurality of merchants where the payment information of users of the set of users UB was used prior to being used at the one or more target merchants MB; for each respective merchant MAi within the set of merchants MA, identifying a respective subset of users UAi from within the set of users UB whose payment information was used at the respective merchant MAi prior to being used at the one or more target merchants MB, and computing a respective probability value P(MAi∩MB) related to the subset of users UAi; for the one or more target merchants MB, computing an overall probability value PB; and for each respective merchant MAi within the set of merchants MA, computing a respective overall probability value PAi. And determining a respective correlation ρ_{MAi,MB} between the one or more target merchants MB and a respective merchant MAi is based on PAi, P(MAi∩MB), and PB.

In an exemplary embodiment, determining the respective correlation ρ_{MAi,MB} between the one or more target merchants MB and the respective merchant MAi based on PAi, P(MAi∩MB), and PB is according to: ρ_{MAi,MB}=(P(MAi∩MB)-PAi*PB)/sqrt(PAi*(1-PAi)*PB*(1-PB)).

In an exemplary embodiment, wherein P(MAi∩MB) corresponds to the number of users in the subset of users UAi divided by the total number of users within the data set; the overall probability value PB corresponds to the number of users within the set of users UB divided by the total number of users within the data set; and the overall probability value PAi corresponds to the number of users which conducted a transaction at the respective merchant MAi within the data set divided by the total number of users within the data set.

In an exemplary embodiment, P(MAi∩MB) corresponds to the number of transactions at the respective merchant MAi by users in the subset of users UAi divided by the total number of transactions within the data set; the overall probability value PB corresponds to the number of transactions which occurred at the one or more target merchants MB within the data set divided by the total number of transactions within the data set; and the overall probability value PAi corresponds to the number of transactions which occurred at the respective merchant MAi within the data set divided by the total number of transactions within the data set.

In an exemplary embodiment, identifying the set of merchants MA further includes applying a filter criteria to exclude merchants with an insufficient number of relevant transactions associated therewith from the set of merchants MA.

In an exemplary embodiment, detecting the potential CPC based on the determined correlations includes comparing the determined correlations to a threshold.

In an exemplary embodiment, determining the respective correlations between the one or more target merchants MB and each respective merchant MAi of the set of merchants MA is based on using a Jaccard index.

In an exemplary embodiment, the responsive operations include: implementing monitoring in connection with payment information used at the detected potential CPC; sending a notification to users who have interacted with the detected potential CPC; deactivating forms of payment corresponding to the payment information used at the detected potential CPC; and/or restricting usage of forms of payment corresponding to the payment information used at the detected potential CPC.

In yet another exemplary embodiment, the present application provides a computing system. The computing system comprises one or more processors and one or more non-transitory computer-readable mediums having processor-executable instructions stored thereon, wherein the processor-executable instructions, when executed by the one or more processors, facilitate: obtaining a data set of transaction data corresponding to a plurality of transactions performed by a plurality of users at a plurality of merchants; obtaining an identification of a common point of compromise (CPC); detecting a potential target merchant at which fraudulent transactions may be taking place using the transaction information and the identification of the CPC, wherein detecting the potential target merchant includes: determining respective correlations between the CPC and each respective merchant MDi of a set of merchants MD, wherein the set of merchants MD includes merchants of the plurality of merchants at which a user's payment information was used in a transaction after being used in a transaction at the CPC; and detecting the potential target merchant based on the determined correlations; and outputting the detected potential target merchant to facilitate responsive operations being performed in response to the detection of the potential target merchant.

In an exemplary embodiment, detecting the potential target merchant further includes: identifying a set of users UC whose payment information was used in a transaction at the CPC; identifying the set of merchants MD, wherein the set of merchants MD includes merchants of the plurality of merchants where the payment information of users of the set of users UC was used after being used at the CPC; for each respective merchant MDi within the set of merchants MD, identifying a respective subset of users UDi from within the set of users UC whose payment information was used at the respective merchant MDi after being used at the CPC, and computing a respective probability value P(MC∩MDi) related to the subset of users UDi; for the CPC, computing an overall probability value PC; and for each respective merchant MDi within the set of merchants MD, computing a respective overall probability value PDi. And determining a respective correlation ρ_{MC,MDiI} between the CPC and a respective merchant MDi is based on PDi, P(MC∩MDi), and PC.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a simplified illustration depicting an exemplary environment in which exemplary embodiments of the present application are applicable.

FIG. 2 is a simplified block diagram depicting an exemplary system for detecting potential CPCs in accordance with an exemplary embodiment of the present application.

FIG. 3A is a timing diagram depicting an exemplary process for detecting a potential CPC and responding to the detection of a potential CPC.

FIG. 3B is a timing diagram depicting another exemplary process for detecting a potential CPC and responding to the detection of a potential CPC.

FIG. 4 is a flowchart illustrating operations performed by a CPC detection system in accordance with an exemplary embodiment.

FIG. 5 is a flowchart illustrating an exemplary process for using information regarding an identified CPC to detect one or more target merchants where fraudulent transactions using payment information obtained from the identified CPC are frequently processed.

### DETAILED DESCRIPTION

A common point of compromise (CPC) is a term which can be used to describe a merchant, such as a business or a person, or an automated teller machine (ATM) or a point-of-sale (POS) device associated therewith, which has been compromised such that a fraudster is able to obtain payment information (such as credit card information, debit card information, bank account information, etc.) therefrom. Although there have been some existing efforts to develop algorithms for identifying a CPC, existing methods suffer from various disadvantages, including high storage requirements, complicated set-up, expensive processing, and unclear results.

Exemplary embodiments of the present application provide for detecting a potential CPC based on determining correlations between merchants in a manner that is faster, easier to set up, and more efficient than existing approaches, and also provides clearer results which are easier to understand. By using a database of transaction information (which may include or from which may be determined information regarding one or more target merchants where fraudulent transactions are taking place), exemplary embodiments of the present application are able to detect a potential CPC based on the potential CPC being correlated to the one or more target merchants where fraudulent transactions are taking place.

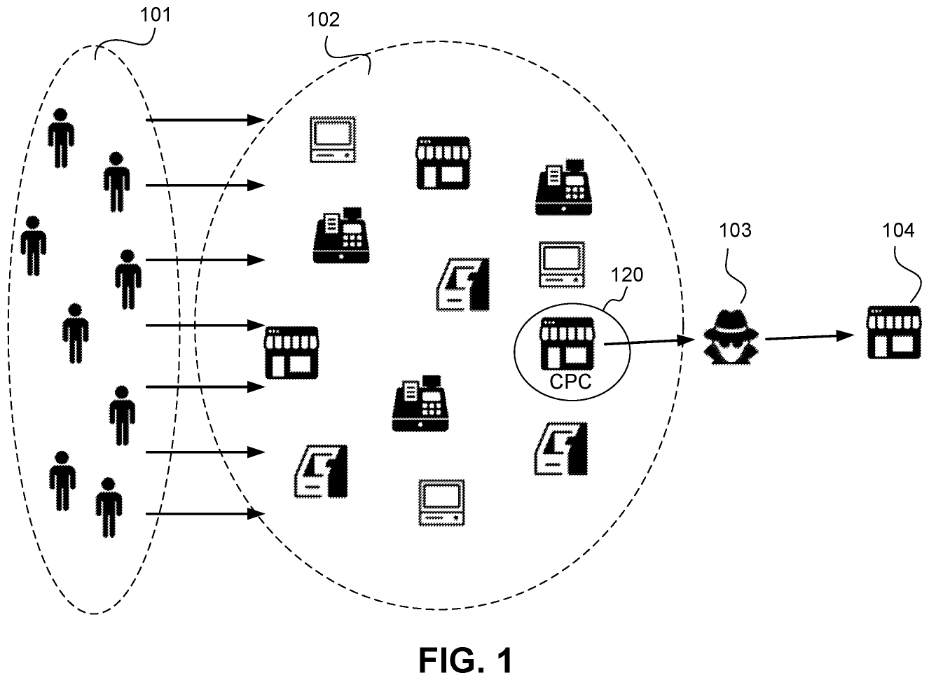

FIG. 1 is a simplified illustration depicting an exemplary environment in which exemplary embodiments of the present application are applicable. The exemplary environment includes a plurality of users 101 interacting with a plurality of merchants 102. The plurality of users 101 interacting with the plurality of merchants 102 may include, for example, credit card transactions, debit card transactions, online transactions, ATM transactions, etc., and the plurality of merchants 102 may include entities or devices such as businesses or persons and/or ATMs, POS devices, or other devices associated with such businesses or persons. When one or more of the plurality of merchants 102 is compromised, such as CPC 120, a fraudster 103 may illicitly obtain stolen payment information from the CPC 120 and use it at one or more target merchants 104 (for example, by generating an illegitimate credit card or debit card having the stolen payment information stored thereon). The target merchant 104 may be a place where fraudulent transactions frequently take place, the fraudulent transactions including unauthorized use of one or more users' illicitly-obtained payment information (such as credit card information, debit card information, banking information, etc.) to obtain money, goods, or services.

Using information regarding the transactions involving the plurality of users 101 and the plurality of merchants 102 which precede the fraudulent transactions taking place at the target merchant 104, exemplary embodiments of the present application are able to identify one or more CPCs 120 among the plurality of merchants 102 with a high degree of confidence. The one or more CPCs 120 may include, for example, a card skimmer installed on a POS device or an ATM, or a compromised database, a compromised web interface or other compromised infrastructure corresponding to a business. The target merchant 104 at which the fraudulent transactions taking place may be, for example, a brick and mortar store, an online store, or a bank. The term “merchant” as used herein may refer to any entity or device where a user's payment information is used to carry out a transaction. In some embodiments, a “merchant” may also include a repository of users' payment information even if the repository itself is not the entity or device carrying out transactions (e.g., in a case where a “merchant” identified as a potential CPC is a hacked database).

It will be appreciated that the exemplary environment depicted in FIG. 1 is merely an example, and that the principles discussed herein may also be applicable to other situations—for example, including other types of merchants, other types of payment information, etc.

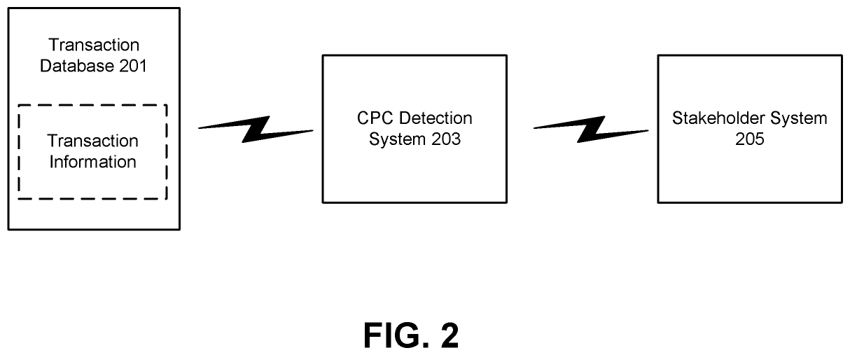

FIG. 2 is a simplified block diagram depicting an exemplary system for detecting potential CPCs in accordance with an exemplary embodiment of the present application. The system includes transaction database 201 which contains transaction information regarding transactions which have taken place between a plurality of users and a plurality of merchants (e.g., collected via a payment processing network from various transaction processing locations). The transaction database 201 may, for example, be part of a computer system controlled by a credit card issuing entity which processes a large volume of transactions. In some exemplary embodiments, the credit card issuing entity may be able to identify fraudulent transactions using conventional algorithms (e.g., using a velocity check model), and stores information regarding both fraudulent and legitimate transactions in the transaction database 201. In other exemplary embodiments, the CPC detection system 203 may identify fraudulent transactions using transaction information from the transaction database 201.

The transaction database 201 may be configured to handle a large amount of data and may be part of a big data processing system. In an exemplary embodiment, the transaction database 201 may be part of an Apache Hadoop environment. In one particular example, the amount of transaction data that was processed was 3.3 GB corresponding to 44,162,798 transactions. It will be appreciated that there may be more or less transaction data in the transaction database 201 in accordance with various exemplary embodiments, for example, up to multiple TBs of data or more.

CPC detection system 203 may include one or more computing nodes (e.g., servers) in communication with the transaction database 201. The CPC detection system 203 may be operated by the same entity as the transaction database 201 (e.g., a credit card issuing entity, a debit card issuing entity, and/or a payment processing entity), or the CPC detection system 203 may be operated by another entity (e.g., such as an insurance or healthcare-related entity in collaboration with an operator of the transaction database 201). For example, in the case of flexible spending account (FSA) and healthcare spending account (HSA) debit cards, a healthcare-related entity may operate a CPC detection system 203 in collaboration with an HSA or FSA payment processing entity which operates the transaction database 201. In another example, the healthcare-related entity may operate both the transaction database 201 and the CPC detection system 203.

CPC detection system 203 may also be part of a big data processing system. For example, the CPC detection system 203 may include a distributed computing network comprising clusters of computing nodes part of an Apache Hadoop environment, wherein each computing node comprises a processor and a non-transitory computer-readable medium having processor-executable instructions stored thereon, and wherein the plurality of computing nodes work together in a distributed manner to perform data processing operations.

It will be appreciated that the analysis performed by the CPC detection system 203 is performed on an amount of transaction data for which it would be impracticable or impossible for a person to manually analyze.

Stakeholder system 205 may correspond to a computing system or a computing device of an entity that has an interest in knowing the identity of a CPC. The entity corresponding to the stakeholder system 205 may be the same entity which operates the transaction database 201 and/or the CPC detection system 203 (e.g., a credit card issuing entity, a debit card issuing entity, a payment processing entity, or an insurance or healthcare provider), or it may include other entities (such as merchants, consumers, law enforcement or other governmental entities, etc.). The CPC detection system 203 is in communication with the stakeholder system 205 to inform the stakeholder system 205 about one or more detected CPCs, such that the stakeholder system 205 may execute remedial actions in response to the detection of a CPC.

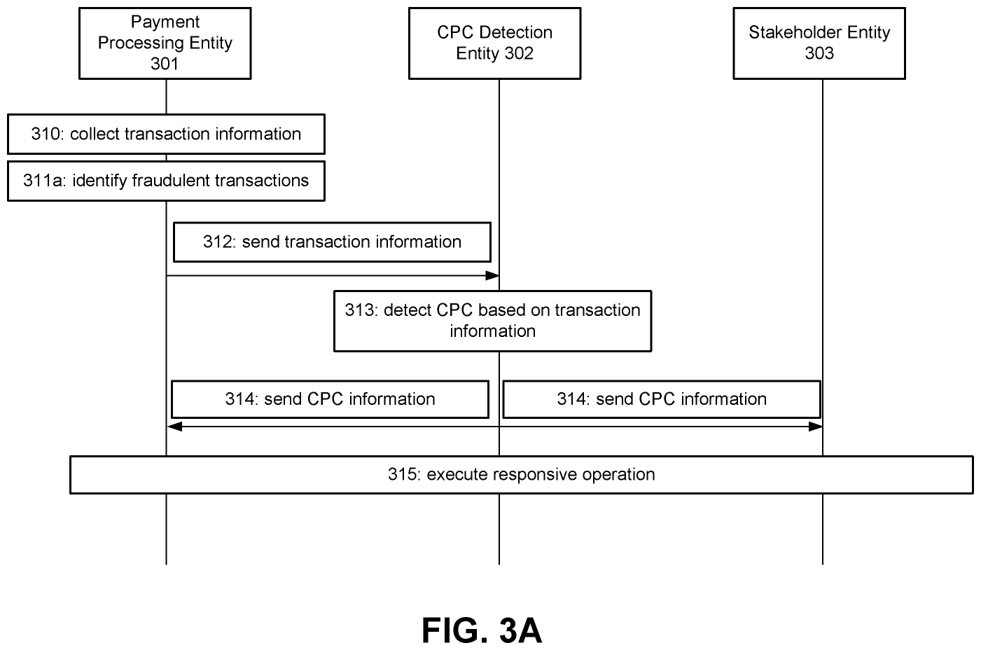

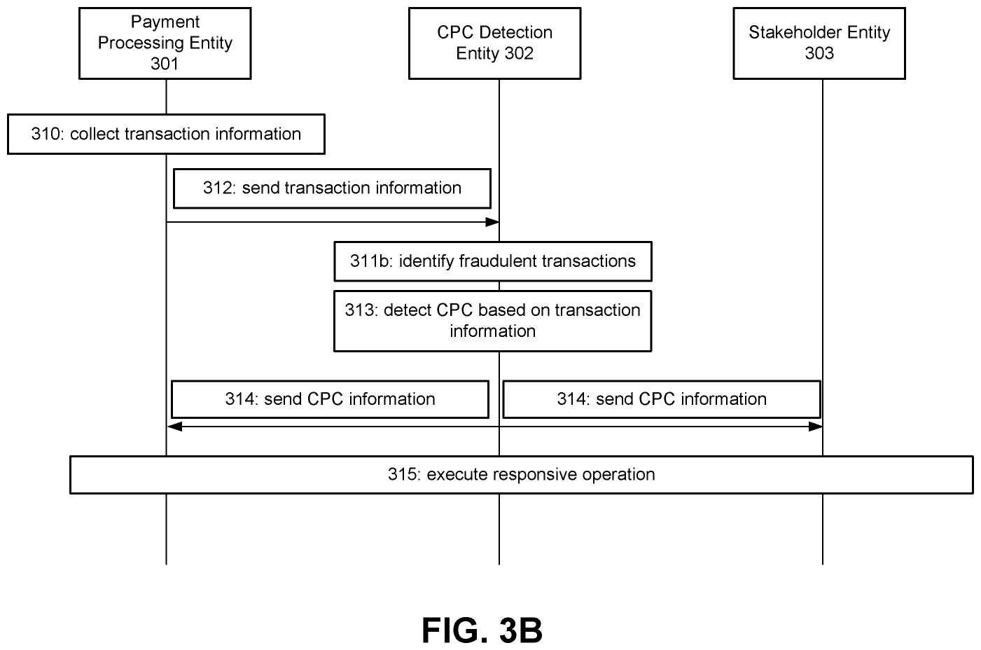

FIG. 3A is a timing diagram depicting an exemplary process for detecting a potential CPC and responding to the detection of a potential CPC. It will be appreciated that although the example depicted in FIG. 3 includes three separate entities (payment processing entity 301, CPC detection entity 302, and stakeholder entity 303), all of the operations discussed herein with respect to FIG. 3 may be performed by a single entity, by two entities, by three entities, or by more than three entities in various exemplary implementations of the present application. For example, in one exemplary implementation, the stakeholder entity 303 may be the same entity as the payment processing entity 301, as the payment processing entity 301 may have an interest in obtaining information regarding a CPC.

At stage 310, the payment processing entity 301 (which, for example, may also be a card issuing entity) collects transaction information corresponding to transactions between a plurality of users and a plurality of merchants. This may include information regarding hundreds, thousands, or even millions of transactions from various transaction processing locations over a time period. In exemplary implementations of the present application, CPCs were accurately identified using transaction data spanning two or three years involving millions of transactions. It will be appreciated, however, that the present application is not limited to data sets of such time periods or of such amounts.

At stage 311a, the payment processing entity 301 identifies fraudulent transactions within the collected transaction information. A conventional manner of identifying fraudulent transactions may be used. For example, a velocity check model may be used to determine an unusually large amount of transactions occurring at a same merchant are potentially fraudulent, with follow-up being performed (e.g., contacting the owner of a credit card used in a potentially fraudulent transaction) to confirm whether a particular transaction or set of transactions was fraudulent.

The identification of the fraudulent transactions may include an identification of one or more target merchants which frequently process fraudulent transactions. For example, the criteria for flagging a merchant as being a target merchant that frequently processes fraudulent transactions may be identifying whether the merchant has processed at least a certain number of fraudulent transactions within a certain time period. To provide another example, a merchant may be flagged as potentially being a target merchant that frequently processes fraudulent transactions based on multiple users conducting transactions at that merchant within a short duration, with follow-up being performed to confirm whether those transactions were fraudulent.

At stage 312, the CPC detection entity 302 obtains the transaction information from the payment processing entity 301, including information regarding legitimate transactions and information regarding fraudulent transactions.

Stage 312 may further include the CPC detection entity 302 obtaining an identification of one or more target merchants which frequently process fraudulent transactions from the payment processing entity 301. Alternatively, using the transaction information obtained in stage 312, the CPC detection entity 302 identifies one or more target merchants which frequently process fraudulent transactions.

At stage 313, using the obtained transaction information and the identification of target merchant(s) which frequently process fraudulent transactions, the CPC detection entity 302 detects one or more potential CPCs. Stage 313 may further include outputting a result of the detection on a computing device of the CPC detection entity 302.

In an exemplary implementation, a computing device associated with the CPC detection entity 302 receives the transaction information from a computing device associated with the payment processing entity 301 via a communication network. In another exemplary implementation, a single computing device or system may be carrying out stages 310, 311a and 313 such that communication between separate entities at stage 312 is unnecessary.

At stage 314, the CPC detection entity 302 may send information regarding one or more entities being detected as potential CPCs to the stakeholder entity 303 and/or to the payment processing entity 301.

At stage 315, the stakeholder entity 303, the payment processing entity 301, and/or the CPC detection entity 302 executes a responsive operation. For example, in response to detection of a potential CPC, one or more of the following responsive operations may be executed via respective computing systems of one or more of the respective entities:
Putting monitoring in place for all cards that have been used at the potential CPC (e.g., the compromised device or merchant), including all cards that have been used at the potential CPC in the past and continuing into the future for any cards that are used at the potential CPC going forward. The monitoring may be automatically set up in a rule-based manner The monitoring may also be implemented in a category-based manner
Automatically notifying all users who have interacted with the potential CPC regarding their payment information potentially being comprised.
Deactivating cards that are used at the potential CPC until the issue is remedied and the potential CPC is confirmed as not being a CPC or as no longer being comprised. This may include, for example, automatically triggering the sending of new cards out to affected users, or disabling existing cards temporarily and requiring users to contact the card issuing entity to request re-enabling of their cards.
Limiting card usage to a certain category of products or services. For example, cards may be limited to only be usable for medical purchases.

In an exemplary implementation, a computing device associated with the stakeholder entity 303 receives the CPC information from the CPC detection entity 302 via a communication network. In another exemplary implementation, a single computing device or computing system may be carrying out stages 313 and 315 such that communication between separate entities at stage 314 is unnecessary.

FIG. 3B is a timing diagram depicting another exemplary process for detecting a potential CPC and responding to the detection of a potential CPC. FIG. 3B is similar to FIG. 3A and the discussion above regarding FIG. 3A is generally also applicable to FIG. 3B, except that in FIG. 3B, instead of the payment processing entity 301 being responsible for identifying fraudulent transactions, the CPC detection entity 302 at stage 311b uses transaction information obtained from the payment processing entity 301 in stage 312 to identify fraudulent transactions.

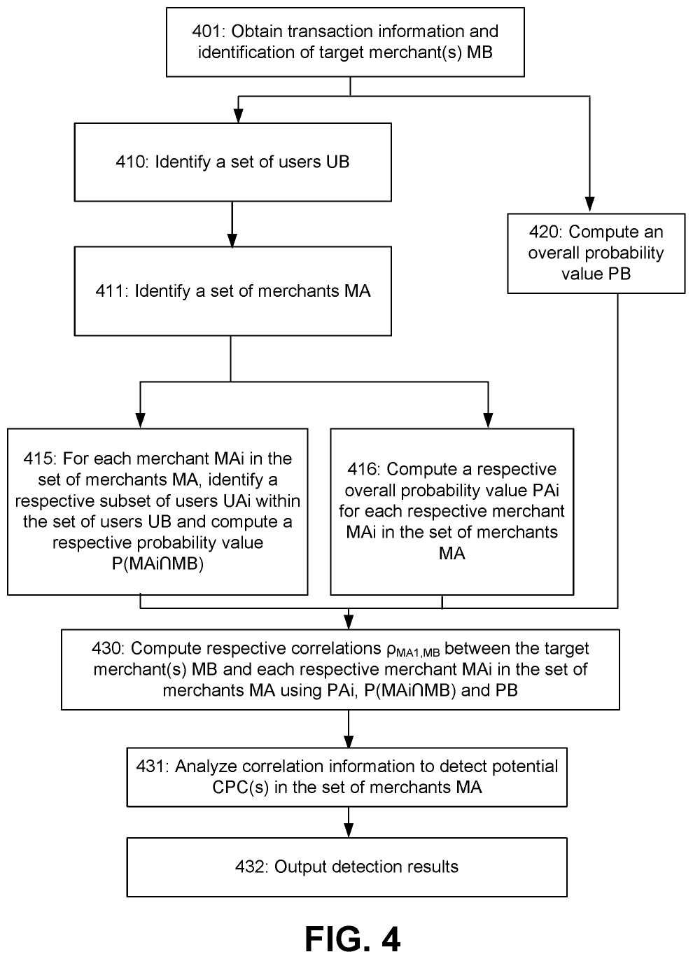

FIG. 4 is a flowchart illustrating operations performed by a CPC detection system in accordance with an exemplary embodiment. The process of FIG. 4 utilizes input transaction information (and a known or determined target merchant or group of target merchants frequently processing fraudulent transactions) in order to generate an output of an identification of one or more potential CPCs.

At stage 401, the CPC detection system obtains transaction information. This transaction information may include information regarding a plurality of transactions taking place at target merchant(s) MB where fraudulent transactions are frequently processed, as well as information regarding a plurality of legitimate transactions at a plurality of other merchants. MB as used within the context of FIG. 4 may refer to a single target merchant or multiple target merchants where fraudulent transactions are frequently processed.

At stage 410, based on the transaction information, the CPC detection system identifies all users UB whose payment information was used in any transaction at target merchant(s) MB (regardless of whether the transaction was fraudulent or not). UB as used within the context of FIG. 4 may thus refer to a set of users comprising multiple users, wherein each user's payment information was used in a transaction at a single target merchant where fraudulent transactions are frequently processed (in the case where MB represents a single target merchant) or at any target merchant of a group of target merchants where fraudulent transactions are frequently processed (in the case where MB represents a group of target merchants).

In another exemplary embodiment, the set of users UB may be limited to all users whose payment information was used in a fraudulent transaction at target merchant(s) MB. This may be preferable when there are a relatively large number of known fraudulent transactions which occurred at target merchant(s) MB. In the case where there are relatively fewer known fraudulent transactions at target merchant(s) MB, it may be advantageous for the set of users UB to include all users whose payment information was used in any transaction at target merchant(s) MB, as this allows fraudulent transactions which have not yet been identified as fraudulent to be factored into the analysis. A different correlation threshold (as described below) may be used for each of these two different situations.

It will be appreciated that each user within the set UB corresponds to a unique instance of payment information. This means that, for the purposes of this analysis, a single person can be considered as multiple users if the single person has multiple forms of payment information. For example, a first user may correspond to a person using his credit card, and a second user may correspond to that same person using his debit card. This also means that, for the purposes of this analysis, the first user's credit card information being legitimately used by the owner of the credit card is considered a transaction associated with the first user, and that the first user's credit card information being fraudulently used by a fraudster at target merchant(s) MB is also considered a transaction associated with the first user.

At stage 411, based on the transaction information, the CPC detection system identifies a set of merchants MA including merchants where the payment information of users within the set of users UB was used prior to being used at target merchant(s) MB. MA as used within the context of FIG. 4 may thus refer to a set of multiple merchants including respective merchants MAi, where i is an index ranging from 1 to N (i.e., the set of merchants MA includes merchant MA1, merchant MA2, . . . merchant MAN), wherein each merchant within the set of merchants MA has processed a transaction using payment information of a user within the set UB prior to the payment information of that user being used at target merchant(s) MB. In a further exemplary embodiment, the set of merchants MA may include entities or devices which act as a repository for user's payment information but which do not process transactions.

At stage 415, based on the transaction information, the CPC detection system identifies, for each respective merchant MAi in the set MA, a respective subset of users UAi within the set UB whose payment information was used at the respective merchant MAi prior to being used at the target merchant(s) MB. Thus, UA1 refers to a subset of users within the set UB whose payment information was used in a transaction at merchant MA1 of the set of merchants MA prior to being used in a transaction at target merchant(s) MB; UA2 refers to a subset of users within the set UB whose payment information was used in a transaction at merchant MA2 of the set of merchants MA prior to being used in a transaction at target merchant(s) MB; . . . ; and UAN refers to a subset of users within the set UB whose payment information was used in a transaction at merchant MAN of the set of merchants MA prior to being used in a transaction at target merchant(s) MB. Further, for each merchant MAi in the set MA, a respective probability value P(MAi∩MB) related to the subset of users UAi is computed. In an embodiment, P(MAi∩MB) represents the probability that a user first conducts a transaction at merchant MAi followed by that user later conducting a transaction (or a fraudulent transaction) at target merchant(s) MB (i.e., the probability of payment information used at merchant MAi later being used at target merchant(s) MB), and P(MAi∩MB) corresponds to the number of users in the subset of users UAi divided by the total number of users within the data set. In an alternative embodiment, P(MAi∩MB) represents the probability of a transaction occurring at merchant MAi using payment information which is later used in a transaction at target merchant(s) MB, and P(MAi∩MB) corresponds to the number of transactions at merchant MAi by users in the subset of users UAi divided by the total number of transactions within the data set.

In an exemplary embodiment, any merchant which processed a transaction using the payment information of a user within the set UB prior to the payment information of that user being used in a transaction (or in a fraudulent transaction) at target merchant(s) MB is included in the set of merchants MA.

In another exemplary embodiment, a filter criteria is used such that only merchants which process transactions using payment information of at least a certain amount of users within the set of users UB prior to the payment information being used in transactions at target merchant(s) MB is included in the set of merchants MA (i.e., to exclude merchants with an insufficient number of relevant transactions associated therewith from the set of merchants MA). The filter criteria may be, for example, to only include a certain merchant within the set of merchants MA if a subset of users within the set UB whose payment information was used at that respective merchant is larger than a threshold. For example, the threshold may require the size of the subset of users to be greater than or equal to a certain percentage of the size of UB (e.g., 25% of the size of UB, or 10% of the size of UB). Including the filter criteria may be helpful to avoid false positives with respect to detecting potential CPCs by excluding merchants having small sample sizes from consideration.

At stage 420, the CPC detection system computes an overall probability value PB associated with the target merchant(s) MB. In an embodiment, the overall probability value PB represents the overall probability of a user conducting a transaction at target merchant(s) MB, and PB corresponds to the number of users within the set of users UB divided by the total number of users within the data set (e.g., the data set of transaction information obtained at stage 401). In an alternative embodiment, the overall probability value PB represents the overall probability of a transaction happening at target merchant(s) MB, and PB corresponds to the number of transactions which occurred at the target merchant(s) MB within the data set divided by the total number of transactions within the data set (e.g., the data set of transaction information obtained at stage 401).

At stage 416, the CPC detection system computes a respective overall probability value PAi for each respective merchant MAi of the set of merchants MA. In an embodiment, each respective overall probability value PAi represents an overall probability of a user conducting a transaction at the respective merchant MAi, and PAi corresponds to the number of users which conducted a transaction at merchant MAi within the data set divided by the total number of users within the data set. In an alternative embodiment, each respective overall probability PAi represents an overall probability of a transaction happening at the respective merchant MAi, and PAi corresponds to the number of transactions which occurred at merchant MAi within the data set divided by the total number of transactions within the data set.

At stage 430, the CPC detection system computes a respective correlation between each respective merchant MAi in the set of merchants MA and the target merchant(s) MB using PAi, P(MAi∩MB), and PB. For example, for a respective merchant MAi in set MA, the correlation ρ_{MAi,MB} between MAi and MB is computed according to ρ_{MAi,MB}=(P(MAi∩MB)-PAi*PB)/sqrt(PAi*(1-PAi)*PB*(1-PB)), where:
MAi represents a merchant where a user conducted a transaction prior to conducting a transaction at target merchant(s) MB;
aᵢ represents a number of users within set UAi;
MB represents a target merchant or group of target merchants where fraudulent transactions using compromised payment information frequently occur;
b represents a number of users within set UB;
P(MAi∩MB) represents the probability that a user first conducts a transaction at merchant MAi followed by that user later conducting a transaction at target merchant(s) MB (i.e., the probability of payment information used at merchant MAi later being used at target merchant(s) MB), where P(MAi∩MB) corresponds to the number of users in the subset of users UAi divided by the total number of users within the data set;
PAi represents the overall probability of a user conducting a transaction at merchant MAi;
PB represents the overall probability of a user conducting a transaction at target merchant(s) MB;
ρ_{MAi,MB} is the correlation between target merchant(s) MB and merchant MAi; and
ρ_{MAi,MB} represents Cov(MAi,MB)/(σaᵢσ_{b}).
   A determination of a correlation value is repeated for each respective merchant MAi in the set of merchants MA (i.e., repeated for each merchant MA1, MA2, . . . MAN) to obtain respective correlation values ρ_{MA1,MB}, ρ_{MA2,MB}, . . . , ρ_{MAN,MB}.

P(MAi∩MB) is proportional to the probability of merchant MAi being compromised. In other words, the larger P(MAi∩MB) is relative to PAi*PB, the more likely it is that transactions at merchant MAi and transactions at target merchant(s) MB are not independent.

σaᵢσb provides for normalization based on sample size. In other words, 6a, provides normalization such that a merchant MAi which generally has a high probability associated therewith is not necessarily determined as being highly correlated to target merchant(s) MB based solely on a large number of users having conducted transactions at merchant MAi.

It will be appreciated that exemplary embodiments of the present application are not limited to the foregoing manner of computing correlation values. Correlation may be determined in other ways, such as by using the Jaccard index.

At stage 431, the CPC detection system analyzes the correlation information to identify potential CPC(s) in the set MA. For example, the analysis may include determining a particular merchant in the set MA having a highest correlation value corresponding thereto, and identifying that merchant as a potential CPC. In another example, the analysis may include comparing correlation values to a threshold value (such as 0.15), and identifying all merchants in the set MA having a correlation value above the threshold as potential CPC(s).

At stage 432, the CPC detection system outputs the identification of potential CPC(s), for example, by displaying results of the analysis on the screen of a computing device and/or by transmitting results of the analysis to a stakeholder device for the stakeholder device to execute responsive operations in response to the identification.

A merchant which has been identified as a potential CPC by the CPC detection system may later be verified as an actual CPC, for example, via a follow-up investigation. For example, an inspection of transaction-processing devices associated with that merchant (e.g., POS devices or ATM machines) may be performed to check whether the devices have been tampered with.

Exemplary embodiments of the present application have been tested and determined to provide effective identification of potential CPCs in real-world scenarios. In one such example, a data set of 44,162,798 transactions was used, spanning approximately a 2.5-year time period. The data set included transactions conducted by 1,692,601 users at a large number of merchants, including a first merchant MA1, a second merchant MA2, and a target merchant MB where fraudulent transactions were determined to occur relatively frequently. The CPC detection system, using this set of data, determined that there were 275 users within set UB, 204 users within set UAL and 28 users within set UA2. The CPC detection system, using this set of data, further determined P(MAI∩MB) to be 0.000120766011708, P(A1) to be 0.0026592202186, P(MA2∩MB) to be 0.0000165757270972, P(A2) to be 0.0194119524016, and P(B) to be 0.000162797319705. This resulted in a correlation of 0.183146188605 between MA1 and MB, and a correlation of 0.00762151160975 between MA2 and MB. MA1 was thus detected as being a potential CPC, whereas MA2 was not detected as being a potential CPC. MA1 was then later confirmed to be a CPC through follow-up investigation.

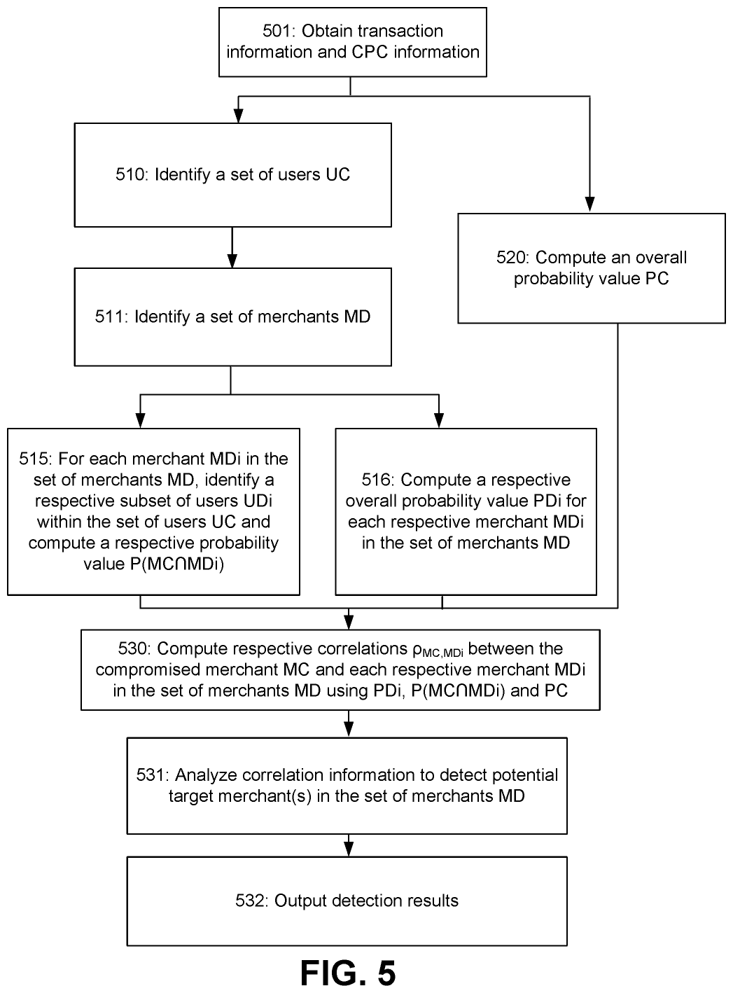

The exemplary embodiments discussed above with respect to FIG. 4 provide for identifying one or more potential CPCs based on transaction information and based on known fraudulent transactions frequently occurring at a particular target merchant or group of target merchants. The principles discussed above in connection with respect to FIG. 4 are also applicable to a situation of detecting one or more potential target merchants where fraudulent transactions might frequently occur based on transaction information and based on an already-identified CPC. FIG. 5 is a flowchart illustrating an exemplary process for using information regarding an identified CPC to detect one or more potential target merchants where fraudulent transactions using payment information obtained from the identified CPC might be frequently processed.

At stage 501, a computing system obtains transaction information and CPC information identifying a CPC (e.g., a compromised merchant MC).

At stage 510, the computing system identifies a set of users UC including all users whose payment information was used at the compromised merchant MC.

At stage 511, the computing system identifies a set of merchants MD including merchants where the payment information of any user within the set UC was used after being used at the compromised merchant MC.

At stage 515, for each merchant in the set MD, the computing system identifies a respective subset of users UDi (including UD1, UD2, . . . , UDN) within the set UC whose payment information was used at each respective merchant MDi (including merchants MD1, MD2, . . . , MDN) in the set of merchants MD after being used at the compromised merchant MC. Further, for each merchant MDi in the set MD, a respective P(MC∩MDi) value is computed, wherein P(MC∩MDi) represents the probability that a user first conducts a transaction at compromised merchant MC followed by that user later conducting a transaction at merchant MDi (i.e., the probability of payment information used at merchant MC later being used at merchant MD), where P(MC∩MDi) corresponds to the number of users in the subset of users UDi divided by the total number of users within the data set. Alternatively, P(MC∩MDi) corresponds to the number of transactions at merchant MDi by users in the subset of users UDi divided by the total number of transactions within the data set.

At stage 520, the computing system computes an overall probability PC of a user conducting a transaction at the compromised merchant MC. Alternatively, the computing system computes an overall probability PC of a transaction happening at the compromised merchant MC.

At stage 516, the computing system computes respective overall probabilities PDi (including PD1, PD2, . . . PDN) of a user conducting a transaction at each respective merchant MDi (including merchants MD1, MD2, . . . , MDN) in the set of merchants MD. Alternatively, the computing system computes respective overall probabilities PDi (including PD1, PD2, . . . PDN) of a transaction happening at each respective merchant MDi (including merchants MD1, MD2, . . . , MDN) in the set of merchants MD.

At stage 530, the computing system computes respective correlations ρ_{MC,MDi} (including ρ_{MC,MD1}, ρ_{MC,MD2}, . . . , ρ_{MC,MDN}) between each merchant in the set of merchants MD and the compromised merchant MC using PDi, P(MC∩MD1) . . . P(MC∩MDN), and PC.

At stage 531, the computing system analyzes the correlation information to detect potential target merchant(s) in the set MD where fraudulent transactions using payment information obtained from compromised merchant MC might be frequently processed, wherein a relatively high correlation (such as a correlation above a threshold value) indicates that a merchant MDi in the set MD is a potential target merchant where fraudulent transactions using payment information obtained from compromised merchant MC might be frequently processed.

At stage 532, the computing system outputs the detected potential target merchant(s) where fraudulent transactions using payment information obtained from compromised merchant MC might be frequently processed.

It will be appreciated that for each of the operations depicted in FIG. 5, implementation details and alternative manners of implementation as discussed above in connection with corresponding operations depicted in FIG. 4 are also applicable, and these details and alternatives are not fully repeated herein in connection with FIG. 5 for brevity. For example, a filter criteria may be used to avoid false positives by limiting the set MD to merchants for which there are at least a certain number of users within the set UC whose payment information was used at the merchant after being used at compromised merchant MC. To provide another example, computations similar to those described above for determining correlation values at stage 430 may also be used to determine correlation values at stage 530.

Once a potential target merchant at which fraudulent transactions might be frequently processed is identified, responsive operations may be performed. For example, transactions taking place at that target merchant may be investigated or analyzed to determine whether the transactions are legitimate or fraudulent. Additionally, remedial measures may be taken to prevent further fraudulent transactions from taking place at the target merchant, including, for example, blocking future transactions from taking place at that target merchant and/or the implementation of heightened security measures and/or monitoring with respect to that target merchant.

It will be appreciated that these figures and their corresponding descriptions are merely exemplary, and that the invention is not limited to these exemplary situations.

It will further be appreciated by those of skill in the art that the execution of the various machine-implemented processes and steps described herein may occur via the computerized execution of processor-executable instructions stored on a non-transitory computer-readable medium, e.g., random access memory (RAM), read-only memory (ROM), programmable read-only memory (PROM), volatile, nonvolatile, or other electronic memory mechanism. Thus, for example, the operations described herein as being performed by computing devices and/or components thereof may be carried out by according to processor-executable instructions and/or installed applications corresponding to software, firmware, and/or computer hardware.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

It will be appreciated that the embodiments of the invention described herein are merely exemplary. Variations of these embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A common point of compromise (CPC) detection system, comprising one or more processors and one or more non-transitory computer-readable mediums having processor-executable instructions stored thereon, wherein the processor-executable instructions, when executed by the one or more processors, facilitate:
obtaining a data set of transaction data corresponding to a plurality of transactions performed by a plurality of users at a plurality of merchants;
obtaining an identification of one or more target merchants MB where fraudulent transactions have taken place;
detecting a potential CPC using the transaction information and the identification of the one or more target merchants MB, wherein detecting the potential CPC includes:
determining respective correlations between the one or more target merchants MB and each respective merchant MAi of a set of merchants MA, wherein the set of merchants MA includes merchants of the plurality of merchants at which a user's payment information was used in a transaction prior to being used in a transaction at the one or more target merchants MB; and
detecting the potential CPC based on the determined correlations; and
outputting the detected potential CPC to facilitate responsive operations being performed in response to the detection of the potential CPC.

2. The CPC detection system according to claim 1, wherein detecting the potential CPC further includes:
identifying a set of users UB whose payment information was used in a transaction at the one or more target merchants MB;
identifying the set of merchants MA, wherein the set of merchants MA includes merchants of the plurality of merchants where the payment information of users of the set of users UB was used prior to being used at the one or more target merchants MB;
for each respective merchant MAi within the set of merchants MA, identifying a respective subset of users UAi from within the set of users UB whose payment information was used at the respective merchant MAi prior to being used at the one or more target merchants MB, and computing a respective probability value P(MAi∩MB) related to the subset of users UAi;
for the one or more target merchants MB, computing an overall probability value PB; and
for each respective merchant MAi within the set of merchants MA, computing a respective overall probability value PAi;
wherein determining a respective correlation ρ_{MAi,MB} between the one or more target merchants MB and a respective merchant MAi is based on PAi, P(MAi∩MB), and PB.

3. The CPC detection system according to claim 2, wherein determining the respective correlation ρ_{MAi,MB} between the one or more target merchants MB and the respective merchant MAi based on PAi, P(MAi∩MB), and PB is according to:
ρ_{MAi,MB}=(P(MAi∩MB)-PAi*PB)/sqrt(PAi*(1-PAi)*PB*(1-PB)).

4. The CPC detection system according to claim 2, wherein P(MAi∩MB) corresponds to the number of users in the subset of users UAi divided by the total number of users within the data set;
wherein the overall probability value PB corresponds to the number of users within the set of users UB divided by the total number of users within the data set; and
wherein the overall probability value PAi corresponds to the number of users which conducted a transaction at the respective merchant MAi within the data set divided by the total number of users within the data set.

5. The CPC detection system according to claim 2, wherein P(MAi∩MB) corresponds to the number of transactions at the respective merchant MAi by users in the subset of users UAi divided by the total number of transactions within the data set;
wherein the overall probability value PB corresponds to the number of transactions which occurred at the one or more target merchants MB within the data set divided by the total number of transactions within the data set; and
wherein the overall probability value PAi corresponds to the number of transactions which occurred at the respective merchant MAi within the data set divided by the total number of transactions within the data set.

6. The CPC detection system according to claim 2, wherein identifying the set of merchants MA further includes applying a filter criteria to exclude merchants with an insufficient number of relevant transactions associated therewith from the set of merchants MA.

7. The CPC detection system according to claim 1, wherein detecting the potential CPC based on the determined correlations includes comparing the determined correlations to a threshold.

8. The CPC detection system according to claim 1, wherein determining the respective correlations between the one or more target merchants MB and each respective merchant MAi of the set of merchants MA is based on using a Jaccard index.

9. The CPC detection system according to claim 1, wherein the responsive operations include:
implementing monitoring in connection with payment information used at the detected potential CPC;
sending a notification to users who have interacted with the detected potential CPC;
deactivating forms of payment corresponding to the payment information used at the detected potential CPC; and/or
restricting usage of forms of payment corresponding to the payment information used at the detected potential CPC.

10. A method for detecting a common point of compromise (CPC) comprising:
obtaining, by a CPC detection system, a data set of transaction data corresponding to a plurality of transactions performed by a plurality of users at a plurality of merchants;
obtaining, by the CPC detection system, an identification of one or more target merchants MB where fraudulent transactions have taken place;
detecting, by the CPC detection system, a potential CPC using the transaction information and the identification of the one or more target merchants MB, wherein detecting the potential CPC includes:
determining respective correlations between the one or more target merchants MB and each respective merchant MAi of a set of merchants MA, wherein the set of merchants MA includes merchants of the plurality of merchants at which a user's payment information was used in a transaction prior to being used in a transaction at the one or more target merchants MB; and
detecting the potential CPC based on the determined correlations; and
outputting, by the CPC detection system, the detected potential CPC to facilitate responsive operations being performed in response to the detection of the potential CPC.

11. The method according to claim 10, wherein detecting the potential CPC further includes:
identifying a set of users UB whose payment information was used in a transaction at the one or more target merchants MB;
identifying the set of merchants MA, wherein the set of merchants MA includes merchants of the plurality of merchants where the payment information of users of the set of users UB was used prior to being used at the one or more target merchants MB;
for each respective merchant MAi within the set of merchants MA, identifying a respective subset of users UAi from within the set of users UB whose payment information was used at the respective merchant MAi prior to being used at the one or more target merchants MB, and computing a respective probability value P(MAi∩MB) related to the subset of users UAi;
for the one or more target merchants MB, computing an overall probability value PB; and
for each respective merchant MAi within the set of merchants MA, computing a respective overall probability value PAi;
wherein determining a respective correlation ρ_{MAi,MB} between the one or more target merchants MB and a respective merchant MAi is based on PAi, P(MAi∩MB), and PB.

12. The method according to claim 11, wherein determining the respective correlation ρ_{MAi,MB} between the one or more target merchants MB and the respective merchant MAi based on PAi, P(MAi∩MB), and PB is according to:
ρ_{MAi,MB}=(P(MAi∩MB)-PAi*PB)/sqrt(PAi*(1-PAi)*PB*(1-PB)).

13. The method according to claim 11, wherein P(MAi∩MB) corresponds to the number of users in the subset of users UAi divided by the total number of users within the data set;
wherein the overall probability value PB corresponds to the number of users within the set of users UB divided by the total number of users within the data set; and
wherein the overall probability value PAi corresponds to the number of users which conducted a transaction at the respective merchant MAi within the data set divided by the total number of users within the data set.

14. The method according to claim 11, wherein P(MAi∩MB) corresponds to the number of transactions at the respective merchant MAi by users in the subset of users UAi divided by the total number of transactions within the data set;
wherein the overall probability value PB corresponds to the number of transactions which occurred at the one or more target merchants MB within the data set divided by the total number of transactions within the data set; and
wherein the overall probability value PAi corresponds to the number of transactions which occurred at the respective merchant MAi within the data set divided by the total number of transactions within the data set.

15. The method according to claim 11, wherein identifying the set of merchants MA further includes applying a filter criteria to exclude merchants with an insufficient number of relevant transactions associated therewith from the set of merchants MA.

16. The method according to claim 10, wherein detecting the potential CPC based on the determined correlations includes comparing the determined correlations to a threshold.

17. The method according to claim 10, wherein determining the respective correlations between the one or more target merchants MB and each respective merchant MAi of the set of merchants MA is based on using a Jaccard index.

18. The method according to claim 10, wherein the responsive operations include:
implementing monitoring in connection with payment information used at the detected potential CPC;
sending a notification to users who have interacted with the detected potential CPC;
deactivating forms of payment corresponding to the payment information used at the detected potential CPC; and/or
restricting usage of forms of payment corresponding to the payment information used at the detected potential CPC.

19. A computing system, comprising one or more processors and one or more non-transitory computer-readable mediums having processor-executable instructions stored thereon, wherein the processor-executable instructions, when executed by the one or more processors, facilitate:
obtaining a data set of transaction data corresponding to a plurality of transactions performed by a plurality of users at a plurality of merchants;
obtaining an identification of a common point of compromise (CPC);
detecting a potential target merchant at which fraudulent transactions may be taking place using the transaction information and the identification of the CPC, wherein detecting the potential target merchant includes:
determining respective correlations between the CPC and each respective merchant MDi of a set of merchants MD, wherein the set of merchants MD includes merchants of the plurality of merchants at which a user's payment information was used in a transaction after being used in a transaction at the CPC; and
detecting the potential target merchant based on the determined correlations; and
outputting the detected potential target merchant to facilitate responsive operations being performed in response to the detection of the potential target merchant.

20. The computing system according to claim 19, wherein detecting the potential target merchant further includes:
identifying a set of users UC whose payment information was used in a transaction at the CPC;
identifying the set of merchants MD, wherein the set of merchants MD includes merchants of the plurality of merchants where the payment information of users of the set of users UC was used after being used at the CPC;
for each respective merchant MDi within the set of merchants MD, identifying a respective subset of users UDi from within the set of users UC whose payment information was used at the respective merchant MDi after being used at the CPC, and computing a respective probability value P(MC∩MDi) related to the subset of users UDi;
for the CPC, computing an overall probability value PC; and
for each respective merchant MDi within the set of merchants MD, computing a respective overall probability value PDi;
wherein determining a respective correlation ρ_{MC,MDi} between the CPC and a respective merchant MDi is based on PDi, P(MC∩MDi), and PC.
